(19) United States
(12) Patent Application Publication
(10) Pub. No.: US 2024/0127308 A1
(43) Pub. Date: Apr. 18, 2024

(54) Mobile In-Store Retail Sales System and Method of Using Same

(71) Applicant: Hibbett Retail, Inc., Birmingham, AL (US)

(72) Inventors: Michael E. Longo, Germantown, TN (US); Charles Mills, Hoover, AL (US); William Timothy Boggess, Trussville, AL (US); Benjamin A. Knighten, Vistavia Hills, AL (US); Michael Bonamy, Hoover, AL (US); Kevin Young, Chandler, AZ (US); Ryan Besterwitch, Denton, TX (US)

(73) Assignee: Hibbett Retail, Inc., Birmingham, AL (US)

(21) Appl. No.: 17/967,401

(22) Filed: Oct. 17, 2022

(51) Int. Cl. G06Q 30/06

(52) U.S. Cl. CPC G06Q 30/0625; G06Q 30/0639; G06Q 30/0643

(57) ABSTRACT

A retail sales system and method for using same are provided. The system may include a mobile in-store terminal having a processor configured to execute a software application configured to receive product search information relating to a requested product, a database configured to store product detail information for a plurality of products, and a server configured to receive the product search information from the mobile in-store terminal, identify one or more products corresponding to the product search information, obtain and provide product detail information related to each of the one or more identified products to the mobile in-store terminal. The mobile in-store terminal may receive product search information that includes a product image of the requested product, a unique visual code corresponding to the requested product, a text code corresponding to the requested product, and a text description corresponding to the requested product.

### TECHNICAL FIELD

Example embodiments of the present disclosure generally relate to retail sales and customer service systems, and more specifically relate to mobile retail sales systems that can more effectively search and suggest products for purchase.

### BACKGROUND

As online sales have become more common in recent years, customers have become accustomed to being able to search for products, filter search results by size, type, or brand, search for related products, complete payment, and set shipping preferences all with just a few keystrokes. However, the traditional retail experience at brick and mortar stores often lacks the same convenience and efficiency. For example, a customer at a sporting goods store wishing to purchase a pair of shoes may ask a sales associate if the shoes are available in a particular size, in response to which the sales associate may go to a stock room to find the particular shoes the client requested, and check to see if the requested size is in stock. If the requested size is not in stock, the customer may ask if a half-size larger or smaller is available, if a similar style shoe is available in the requested size, or if the requested shoe and size are available at another brick and mortar store within the same chain of stores. Each of these requests entails the sales associate going back to the stock room or to stationary cash register away from the customer to check for a different size, trying to determine an alternative shoe that the customer may like, and/or contacting other stores to speak to other sales associates who would need to perform their own search for the requested product.

These challenges often combine to result in a customer experience that is frustrating and slow, and many times fails to match the customer with products the customer is seeking, even if the retailer is able to provide the products in the requested size and style. Accordingly, there is a need for a mobile retail sales system that may address one or more of these problems.

### SUMMARY

According to an aspect of one or more example embodiments, there is provided a retail sales system, which may include a mobile in-store terminal having a processor configured to execute a software application configured to receive product search information relating to a requested product, a database configured to store product detail information for a plurality of products, and a server configured to receive the product search information from the mobile in-store terminal, identify one or more products corresponding to the product search information, and obtain product detail information related to each of the one or more products from the database, and provide the product detail information related to each of the one or more identified products to the mobile in-store terminal. The mobile in-store terminal may be configured to receive product search information that includes a product image of the requested product, a unique visual code corresponding to the requested product, a text code corresponding to the requested product, and a text description corresponding to the requested product

The product search information may include the requested product image. The server may include an image processing unit having a processor configured to extract image data from the requested product image. The server may be configured to identify the one or more products based on the extracted image data.

The server may be configured to identify, based on the extracted image data, additional products having a color, shape, or type corresponding to the one or more identified products. The product search information may include size information relating to the requested product. The product detail information provided by the server to the mobile in-store terminal may indicate availability of each of the one or more identified products having a size with a predetermined range of the size information.

The product detail information provided by the server to the mobile in-store terminal may include location information for each of the one or more identified products. The location information for each of the one or more identified products may indicate whether the product is located at a physical store where the mobile in-store terminal is located, at a physical store within a predetermined distance of the physical store where the mobile in-store terminal is located, at a physical store outside of the predetermined distance of the physical store where the mobile in-store terminal is located, in online inventory, or inventory made available directly from vendor partners.

The database may be configured to store complementary product information related to complementary products associated with one or more of the plurality of products. The server may be configured to provide to the mobile in-store terminal complementary product information related to complementary products associated with each of the one or more identified products.

The mobile in-store terminal may be configured to create a plurality of virtual shopping bags respectively corresponding to a plurality of customers, and add products to the plurality of virtual shopping bags based on a user input. The mobile in-store terminal may be configured to delete a virtual shopping bag of the plurality of virtual shopping bags based on the virtual shopping bag not being accessed for a predetermined period of time.

The mobile in-store terminal may be configured to create and display a plurality of virtual shopping bags respectively corresponding to a plurality of customers, and add products to the plurality of virtual shopping bags based on user input. When displaying products of a virtual shopping bag, the mobile in-store terminal may be configured to display a unique visual code for each product located at a physical store within a predetermined distance of the physical store where the mobile in-store terminal is located, or at a physical store outside of the predetermined distance of the physical store where the mobile in-store terminal is located. The server may be configured to initiate a first payment and shipping process for each product in the virtual shopping bag located at a physical store within or outside a predetermined distance of the physical store where the mobile in-store terminal is located, based on the unique visual code for said each product.

When displaying products of a virtual shopping bag, the mobile in-store terminal may be configured to display a unique visual code for each product located in online inventory. The server may be configured to initiate a second payment and shipping process for each product in the virtual shopping bag located in online inventory, based on the unique code for each said product located in online inventory.

The product search information may include the unique visual code corresponding to the requested product. The mobile in-store terminal may include a visual code scanner configured to decode the unique visual code and transmit decoded information to the server. The server may be configured to identify the one or more products based on the decoded information, and identify additional products having a color, shape, or type corresponding to the one or more identified products.

The product search information may include the text code corresponding to the requested product. The server may be configured to identify the one or more products based on the text code, and identify additional products having a color, shape, or type corresponding to the one or more identified products.

The product search information may include the text description corresponding to the requested product. The server may be configured to identify the one or more products based on the text description, and identify additional products having a color, shape, or type corresponding to the one or more identified products.

According to an aspect of one or more example embodiments, there is provided a method of using a retail sales system. The method may include receiving, at a mobile in-store terminal, product search information relating to a requested product, storing product detail information for a plurality of products, receiving the product search information from the mobile in-store terminal, identifying one or more products corresponding to the product search information, and providing product detail information related to each of the one or more identified products to the mobile in-store terminal. The mobile in-store terminal is configured to receive product search information that includes a product image of the requested product, a unique visual code corresponding to the requested product, a text code corresponding to the requested product, and a text description corresponding to the requested product.

The product search information may include the requested product image. The method may also include extracting image data from the requested product image, and the step of identifying the one or more products corresponding to the produce search information may include identifying said one or more products based on the extracted image data.

The method may also include identifying additional products having a color, shape, or type corresponding to said one or more identified products. The product search information may include size information relating to the requested product, and wherein the product detail information provided to the mobile in-store terminal indicates availability of each of the one or more identified products having a size with a predetermined range of the size information.

The product detail information provided to the mobile in-store terminal may include location information for each of the one or more identified products. The location information may indicate whether the product is located at a physical store where the mobile in-store terminal is located, at a physical store within a predetermined distance of the physical store where the mobile in-store terminal is located, at a physical store outside of the predetermined distance of the physical store where the mobile in-store terminal is located, in online inventory, or inventory made available directly from vendor partners.

The method may also include storing complementary product information related to complementary products associated with one or more of the plurality of products, and providing the mobile in-store terminal complementary product information related to complementary products associated with each of the one or more identified products.

The method may also include adding one or more of said identified products to a virtual shopping bag, displaying, on the mobile in-store terminal, products within the virtual shopping bag, displaying a unique visual code for each product in the virtual shopping bag located at a physical store within a predetermined distance of the physical store where the mobile in-store terminal is located, or at a physical store outside of the predetermined distance of the physical store where the mobile in-store terminal is located, and initiating a first payment and shipping process for each product in the virtual shopping bag located at a physical store within or outside a predetermined distance of the physical store where the mobile in-store terminal is located, based on the unique visual code for said each product in the virtual shopping bag.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates a block diagram of a retail sales system according to various example embodiments.

FIG. 2A illustrates an example of a home screen of a software application operating on the mobile in-store terminal according to various example embodiments.

FIG. 2B illustrates an example of an image capture screen of a software application operating on the mobile in-store terminal according to various example embodiments.

FIG. 2C illustrates an example of a visual code capture screen of a software application operating on the mobile in-store terminal according to various example embodiments.

FIG. 2D illustrates an example of a text input screen of a software application operating on the mobile in-store terminal according to various example embodiments.

FIG. 2E illustrates an example of a size selection screen of a software application operating on the mobile in-store terminal according to various example embodiments.

FIG. 3 illustrates a process of determining and providing the inventory search results according to various example embodiments.

FIG. 4A illustrates an example of a search results screen of a software application operating on the mobile in-store terminal according to various example embodiments.

FIG. 4B illustrates an example of a product screen of a software application operating on the mobile in-store terminal according to various example embodiments.

FIG. 4C illustrates an example of a similar results screen of a software application operating on the mobile in-store terminal according to various example embodiments.

FIG. 4D illustrates an example of a product screen of a software application operating on the mobile in-store terminal according to various example embodiments.

FIG. 5A illustrates a virtual shopping bag of a software application operating on the mobile in-store terminal according to various example embodiments.

FIG. 5B illustrates an alternate view of a virtual shopping bag of a software application operating on the mobile in-store terminal according to various example embodiments.

FIG. 5C illustrates yet another alternate view of a virtual shopping bag of a software application operating on the mobile in-store terminal according to various example embodiments.

FIG. 5D illustrates yet another alternate view of a virtual shopping bag of a software application operating on the mobile in-store terminal according to various example embodiments.

### DETAILED DESCRIPTION OF EXAMPLE EMBODIMENTS

Reference will now be made in detail to the following various examples, which are illustrated in the accompanying drawings, wherein like reference numerals refer to like elements throughout. The following examples may be embodied in various forms without being limited to the examples set forth herein.

This description of the example embodiments is intended to be read in connection with the accompanying drawings, which are to be considered part of the entire written description. The use of the singular includes the plural unless specifically stated otherwise. As used in the specification, the singular forms “a,” “an” and “the” include plural referents unless the context clearly dictates otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

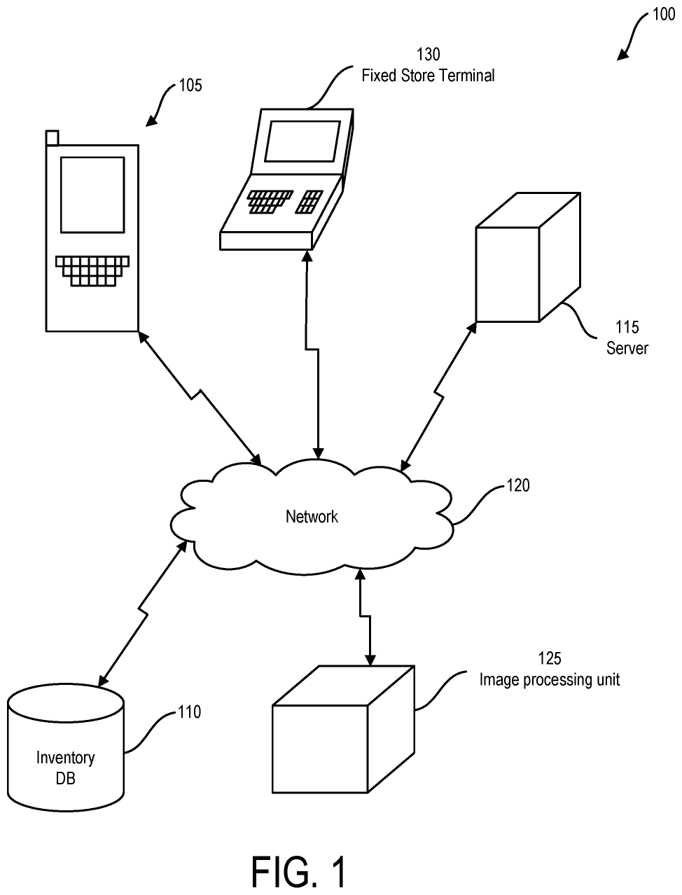

FIG. 1 illustrates a block diagram of a retail sales system according to various example embodiments. Referring to FIG. 1, the retail sales system 100 may include a mobile in-store terminal 105 having a processor configured to execute software applications, an inventory database 110 configured to store product detail information for a plurality of products, a server 115 configured to communicate with the mobile in-store terminal 105 via a network 120 (e.g., Internet, Wide Area Network (WAN), Local Area Network (LAN), etc.), an image processing unit 125 configured to process and extract information from a variety of images, and a fixed store terminal 130 for processing retail transactions. Each of the components of the example retail sales system 100 shown in FIG. 1 may be configured to communicate with each other via network 120. The mobile in-store terminal 105 may be deployed within a brick and mortar retail store that sells various products. The mobile in-store terminal 105 may have a camera that is capable of capturing images of products a consumer may wish to purchase, a microphone for receiving verbal input, a wireless transceiver for communicating with other components of the retail sales system 100 via network 120, a processor for executing mobile applications and controlling the camera, microphone, and wireless transceiver, and a memory.

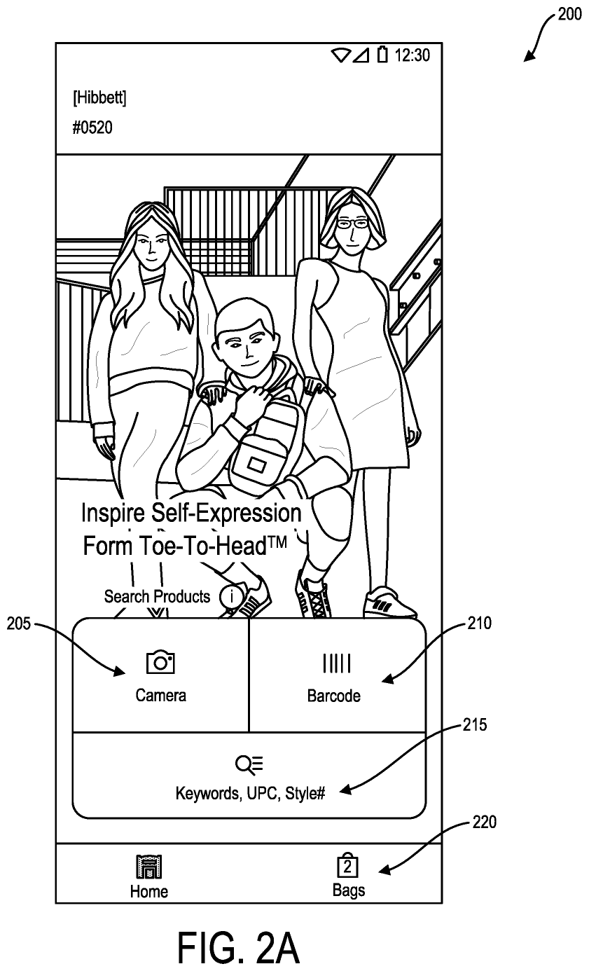

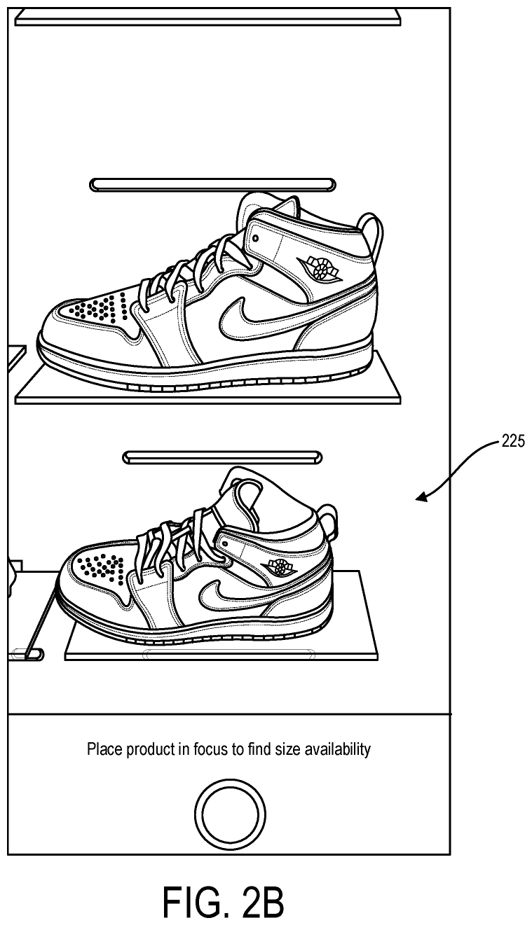

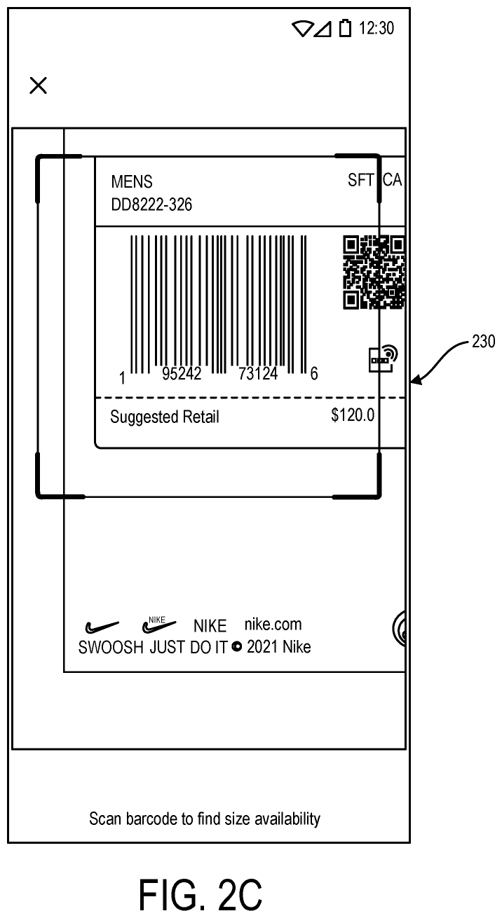

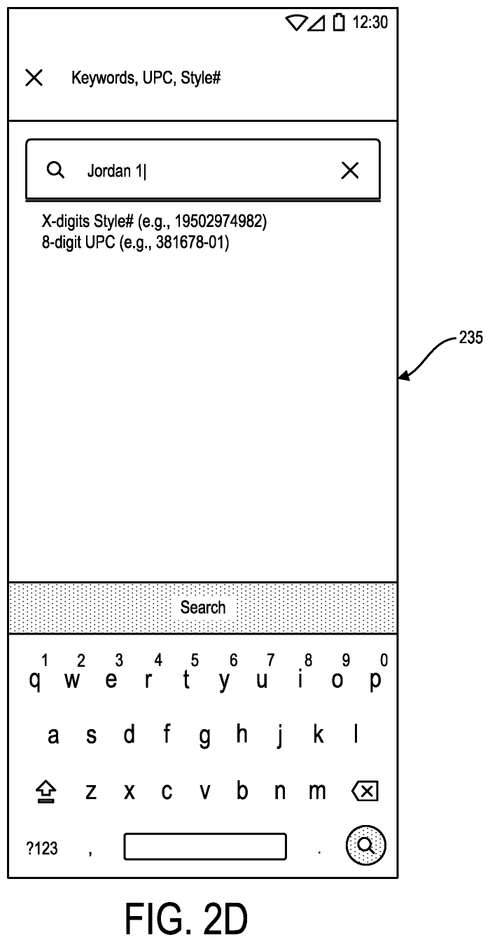

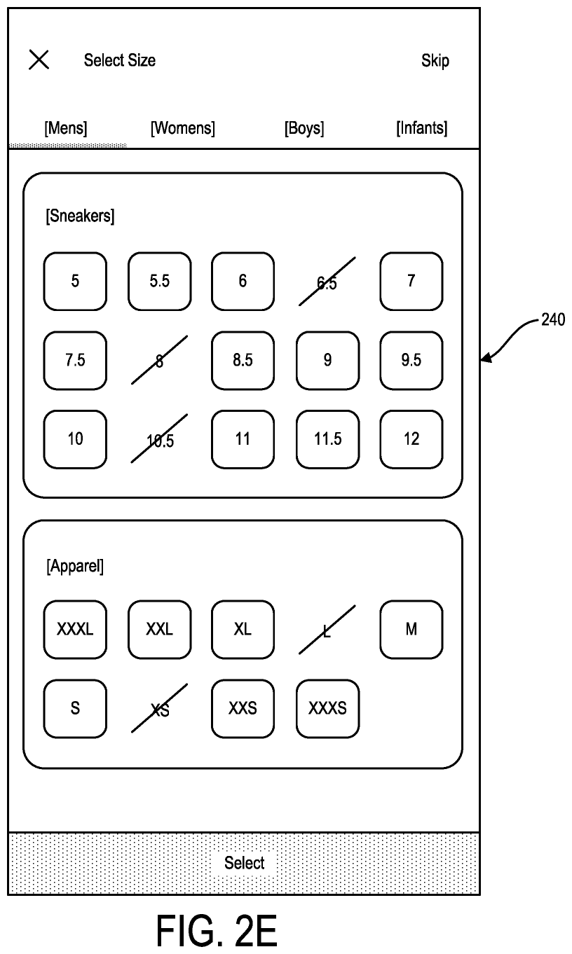

FIG. 2A illustrates an example of a home screen of a software application operating on the mobile in-store terminal 105 according to an example embodiment. The mobile application may cause home screen 200 to be displayed on the mobile in-store terminal 105, and may include multiple options for inputting product search information for a requested product a customer wishes to purchase or review. For example, the home screen 200 may include a camera option 205 to capture an image of the requested product using the camera of the mobile in-store terminal 105. For example, a customer that wishes to try on and/or purchase a pair of shoes, may pick up a display shoe corresponding to the shoes the customer wishes to purchases, and provide the display shoe to a sales associate to capture an image of the display shoe using the camera of the mobile in-store terminal 105. The captured image is an example of product search information that may be used to find additional product detail information relating to the product, as described in more detail below.

The home screen 200 may also include a visual code option 210 to capture product search information using a unique visual code corresponding to the requested product, such as a barcode, QR code, or the like. The mobile in-store terminal 105 may include visual code reader or scanner that is configured to decode the unique visual code and extract information related to the product associated with the unique visual code.

The home screen 200 may also include a text option 215 to receive product search information in the form of a text code, such as a Universal Product Code (UPC), a Stock Keeping Unit (SKU) number, or any other alpha-numeric code that may be uniquely associated with the requested product. In addition, the text option 215 may be configured to receive product search information in the form of keywords, which may be, for example, a text description of the name, style, brand, or type of the requested product. The home screen 200 may also include a virtual bag icon 220 that, when selected, is configured to display the contents of one or more virtual bags, as described in more detail below.

Although not depicted in FIG. 2A, the home screen 200 may include a voice option that enables the microphone of the mobile in-store terminal 105 to receive verbal communications from a user, and convert the verbal communications into electrical signals. For example, the user may say the name or other identifying elements of the product, which are captured and converted by the microphone for further processing.

If the store associate selects the camera option 205 from the home screen, the mobile application activates the camera of the mobile in-store terminal 105 to display an image capture screen 225, as shown in FIG. 2B, to capture an image of the searched product. If the store associate selects the visual code option 210, the mobile application activates an application that is configured to capture a visual code, as shown in a visual code capture screen 230 in FIG. 2C, using the camera of the mobile in-store terminal 105. If the store associate selects the text option 215, the mobile application causes a text input screen 235, as shown in FIG. 2D, to be displayed on the mobile in-store terminal 105 for receiving text input of a UPC, SKU number, and/or a description of the requested product. Once the sales associate has entered the product search information, e.g., by capturing the image of the requested product, capturing a unique visual code associated with the requested product, or entering a text description corresponding to the requested product, the mobile application may cause the mobile in-store terminal 105 to display a size selection screen 240, as shown in FIG. 2E, to receive size information. The size selection screen 240 may allow the sales associate to choose between different size categories, such as sizes for sneakers and apparel, select whether the size is men's, women's, children's, or infant's size, and select the specific size the customer is seeking.

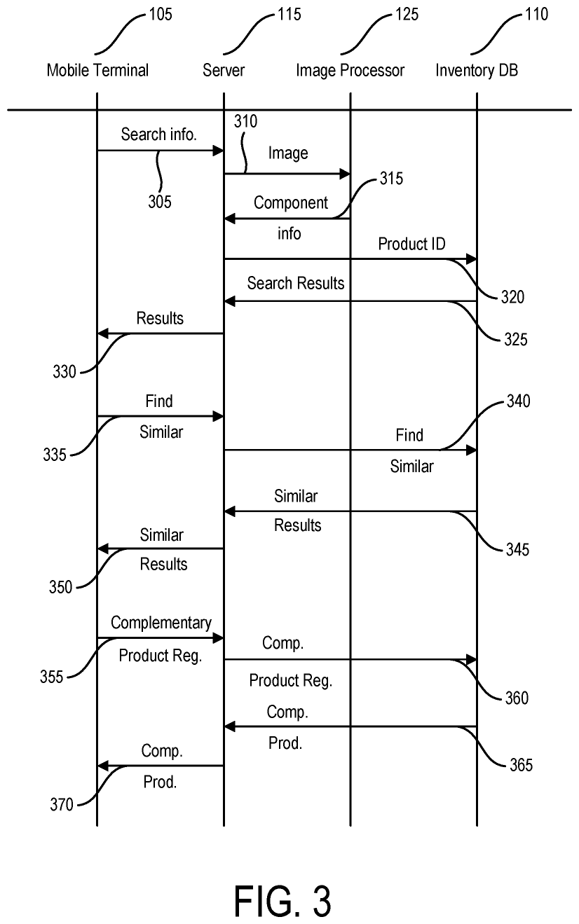

Once the product search information has been received by the mobile in-store terminal 105, the retail sales system 100 may identify the relevant product and determine the corresponding available inventory. For example, FIG. 3 shows a process of determining and providing the inventory search results based on the product search information received by the mobile in-store terminal 105. Referring to FIG. 3, in step 305 the mobile in-store terminal 105 may transmit a request containing the product search information, in the form of a requested product image captured by the camera of the mobile in-store terminal 105, to the server 115. In step 310, the server 115 may transmit the requested product image to the image processing unit 125. The image processing unit 125 may analyze the requested product image, and may provide, in step 315, the server 115 with image component information relating to the requested product image. For example, the image component information may include a shape, type, and/or color(s) of the requested product. The server 115 may then identify the requested product based on the component information, and transmit, in step 320, a product ID of the requested product to the inventory database 110. For example, the server 115 may include data relating to various products that are available for purchase, and may identify the requested product and determine the corresponding product ID by comparing the component information received from the image processing unit 125 to the product data stored in the server 115. The product ID may be a name, identification number, or other indication relating to the product by which the inventory database 110 can search to determine the current inventory of the requested product. Alternatively, the image processing unit 125 may store information data relating to various products available for purchase, and may identify the requested product and the corresponding product ID in the same manner, and transmit the product ID of the requested product to the server 115 in step 315. In step 320, the server 115 may also transmit size information received via the size selection screen 240 to the inventory database 110, in addition to the product ID of the requested product. Although the image processing unit 125, the inventory database 110, and the server 115 are depicted as separate components, they may be implemented as one or more components.

According to yet another example embodiment, the mobile in-store terminal 105 may transmit the requested product image to the server 115 in step 305, and the server 115 may transmit the requested product image to the image processing unit 125 in step 310. The image processing unit 125 may include a plurality of product images, and may compare the requested product image received from the server 115 to the plurality of product images, and determine a relevance score for each of the plurality of product images based on the comparisons.

If the product search information is a unique visual code, steps 310 and 315 may be omitted, and the product search information may be decoded by the mobile in-store terminal 105 and transmitted to the inventory database 110 in step 320. Likewise, if the product search information that is transmitted to the server 115 in step 305 is a text code, such as an SKU number of UPC, the server 115 may determine a product ID corresponding to the requested product based on the text code, and transmit the product ID to the inventory database 110 in step 320. If the product search information that is transmitted to the server 115 in step 305 is a text description of the requested product, the server 115 may determine a product ID corresponding to the requested by comparing keywords contained in the text description with keywords stored in server 115 for each product available for purchase. The server 115 may then transmit the product ID to the inventory database 110 in step 320. Alternatively, in step 320, the server 115 may transmit the text description received from the mobile in-store terminal in step 305 to the inventory database 110, which may determine the requested product by comparing keywords contained in the text description with keywords associated stored in the inventory database 110 for each available product.

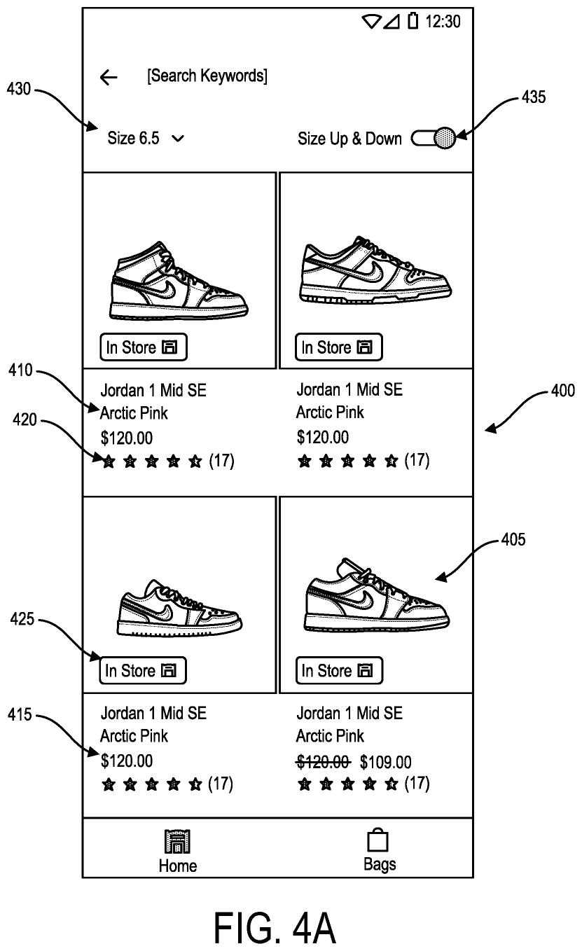

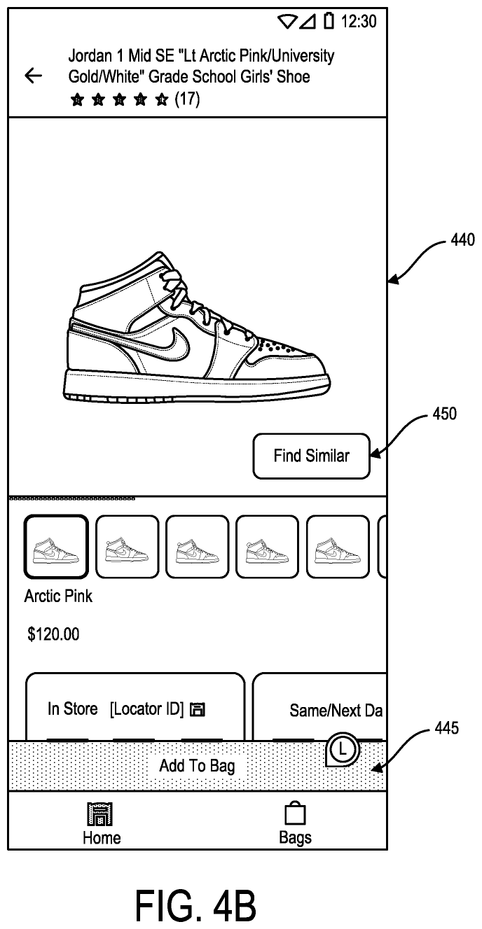

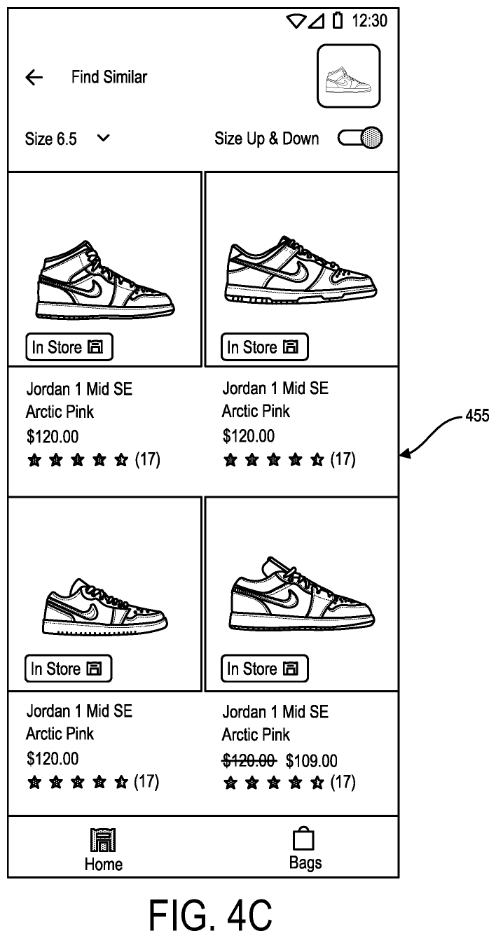

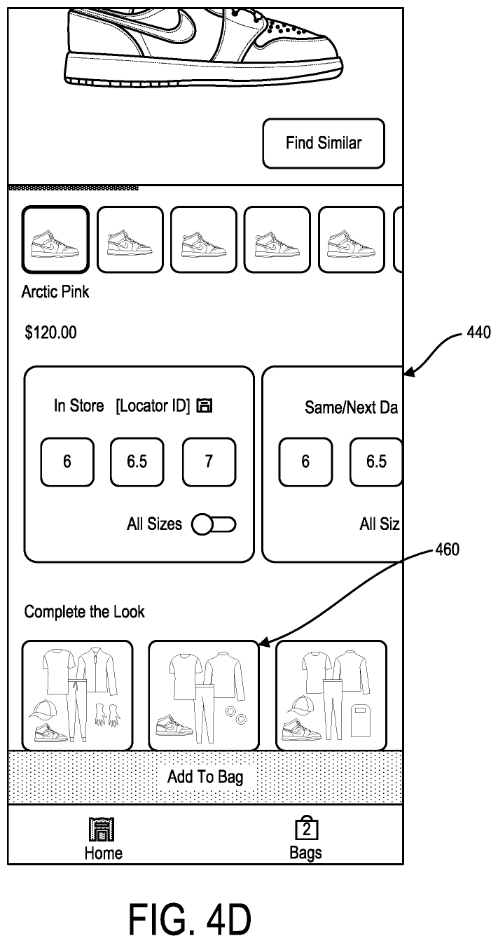

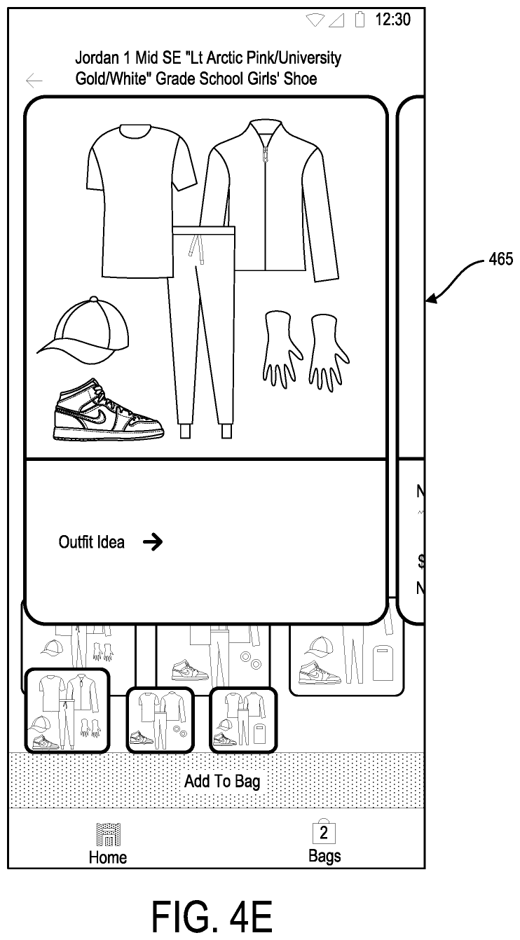

In step 325, the inventory database 110 may transmit to the server 115 product detail information for each product corresponding to the product ID received by the inventory database 110 in step 320. The product detail information may include photographs, text descriptions, customer reviews, location information, and price information, for example. According to an example embodiment in which the image processing unit 125 compares a requested product image with a plurality of images and determines a relevance score for each of the plurality of images based on the comparisons, the image processing unit 125 may identify each product corresponding to an image that exceeds a certain threshold relevance score, and request the inventory database 110 to provide product detail information for each identified product of the mobile in-store terminal 105. If size information was transmitted to the inventory database 110 in step 320, the inventory database may return product detail information for products currently in inventory that match the provided size information or are within a predetermined variance of the provided size information. For example, if the size information indicates that the user is seeking a size 6.5 shoe, the inventory database 110 may provide product detail information for the requested product in sizes 6, 6.5, and 7. The product detail information may be transmitted to the mobile in-store terminal 105 in step 330, and which may display the product detail information on a search results screen 400 on the mobile in-store terminal 105, as shown in FIG. 4A. The search results screen 400 may include various types of product detail information, including a photograph 405, color information 410, price information 415, customer rating information 420, and a location indicator 425 indicating whether the particular product in the particular size is located in the same physical store as the mobile in-store terminal 105, is located at another store within the same “hub” as (i.e., within a certain radius of) the store in which the mobile in-store terminal 105 is located, or is located at any other store in the entire “chain” of stores. The search results screen 400 may include a size indicator 430 indicating the size that was specified by the user or sales associate when submitting the product search information. The search results screen may also include size variation indicator 435 (indicated as “Size Up & Down”), which may be selected or de-selected by the sales associate or the user. If the size variation indicator 435 is selected, the search results screen 400 will include search results that fall within a predetermined range of the specified size. For example, if the customer or sales associate indicated a shoe size of 6.5, when the size variation indicator 435 is selected, the search results screen 400 may include the requested shoes available in sizes 6, 6.5, and 7.

When the user or sales associate selects one of the products shown in the search results screen 400, a product page 440 may be displayed on the mobile in-store terminal 105. The product page 440 may include a purchase option 445 that allows the user or sales associate to add the product to a virtual shopping bag. The product page 440 may also include a “find similar” option 450, which allows the user or sales associate to find products that may be similar to the requested product. Referring again to FIG. 3, when the “find similar” option 450 is selected, the mobile in-store terminal 105 transmits a request in step 335 to the server 115 providing product detail information or a product ID of the product for which the user wishes to see similar products. In step 340, the server 115 transmits the request to the inventory database 110, which will identify similar products by comparing style, color, size, item type, etc. of the requested product to the corresponding feature of other products stored in the inventory database 110. In particular, the inventory database 110 may search across (1) the same store where the mobile in-store terminal 105 is located (and where the customer is located), (2) other stores within the same “hub” (i.e., at a store within a predetermined distance from the store where the customer is located), (3) any other stores within the entire chain of stores, (4) online inventory that is used to fulfill online orders, and/or (5) inventory from the manufacturer or distributor of the product that may be able to drop ship the product to the customer. For example, a search may be initiated based on data in flat files (CSV) for different areas/systems for a given product. More specifically, a search may include searching inventory data representing inventory at one or more distribution centers used for fulfilling online orders, and may also include inventory data associated with manufacturers, distributors, and vendors that are able to dropship the requested product to the customer. The search may also include polling servers associated with individual brick and mortar store locations to determine availability of the requested product at each store location within the chain. The search may also include searching inventory data stored in an order broker server that may include inventory data for all store locations. At the time of selecting the product, a live inquiry may be made through the different systems to verify the search results and availability of the requested product. In step 345, the inventory database 110 transmits similar search results containing product information corresponding to products the inventory database 110 has determined to be similar to the requested product, and the similar search results and transmitted to and displayed on the mobile in-store terminal in step 350. The inventory database 110 may determine products similar to the requested product by, for example, comparing product images to an image of the requested product. The inventory database 110 may determine a relevance value for each product based on a comparison of the product image to the image of the requested product, and determine that products having a relevance value above a certain threshold are similar to the requested product, and return product information for those products exceeding the threshold. For example, FIG. 4C illustrates a similar results screen 455 that may be displayed on the mobile in-store terminal 105, which may include a plurality of products that have been determined to be similar to the requested product.

Referring to FIG. 4D, the product page 440 may also include a complementary option 460 to “complete the look” around the requested product. For example, if the requested product is a pair of shoes, the product page 440 may include a photograph of the product, size, color, and shipping options, and a complementary option 460, which may provide suggestions for other complementary products, such as shirts, pants, hats, accessories, etc. that may complement the requested shoes. Referring again to FIG. 3, upon selection of the complementary option 460, the mobile in-store terminal 105 transmits in step 355 a request for complementary products to the server 115. The server 115 may identify products that are complementary to the requested product by comparing style, color, size, item type, etc. of the requested product with similar attributes of other products that are available for purchase. Alternatively, the server 115 may forward the request for complementary products it received in step 355 to the inventory database 110 in step 360, and the inventory database may identify complementary products to the requested product. According to an example embodiment, the complementary products that complement the requested product may be predetermined, and the inventory database 110 may store data for each product indicating which other products are complementary. In step 365, the inventory database 110 may transmit product detail information for complementary products that were identified by the inventory database 110 to the server 115, which may transmit the product detail information for the complementary products to the mobile in-store terminal 105. For example, referring to FIG. 4E, the mobile in-store terminal 105 may display a complementary product page 465 that includes photographs and other descriptive information relating to the complementary products that complement the requested product. In this example, the complementary product may displays photographs of a hat, shirt, pants, gloves and jacket that may complement the requested shoes. The complementary product page 465 may also allow the user to add one or more of the complementary products to a virtual shopping bag.

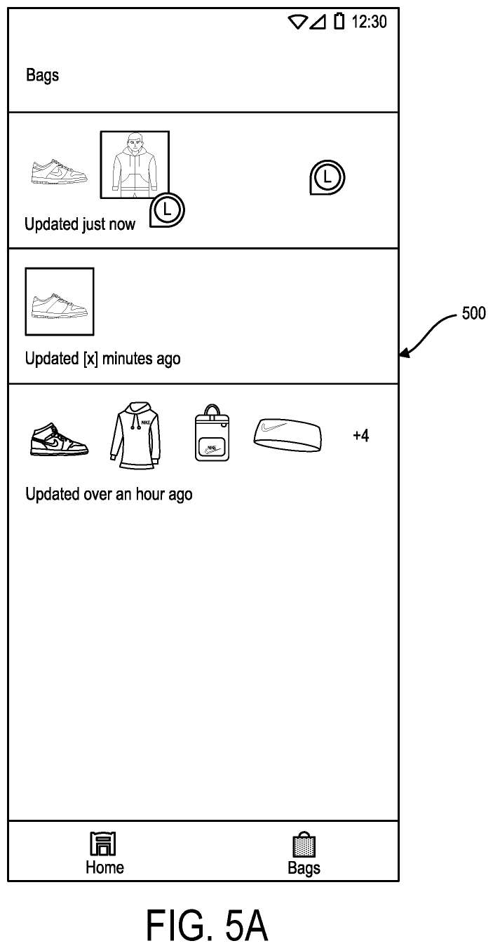

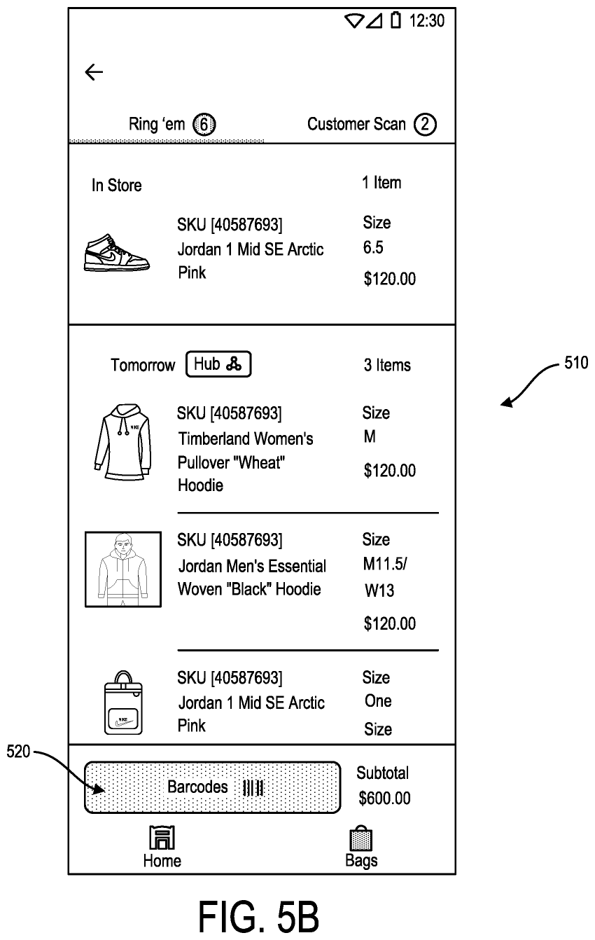

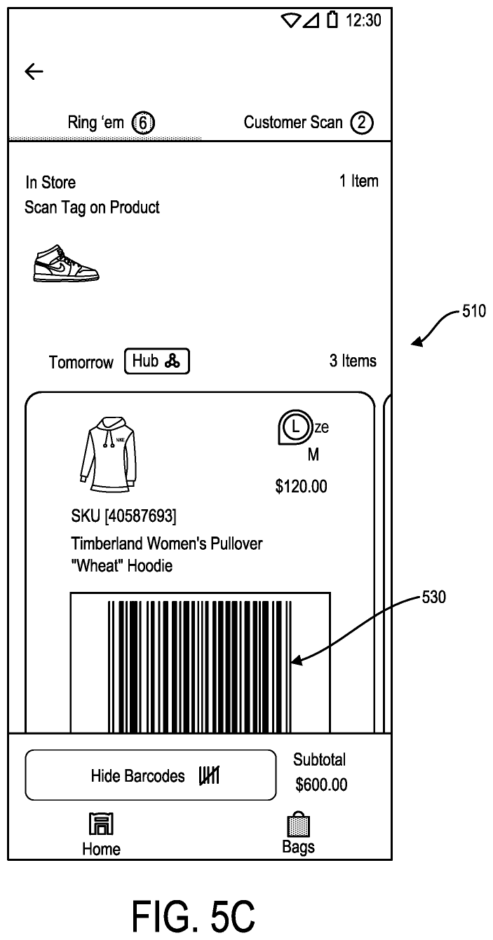

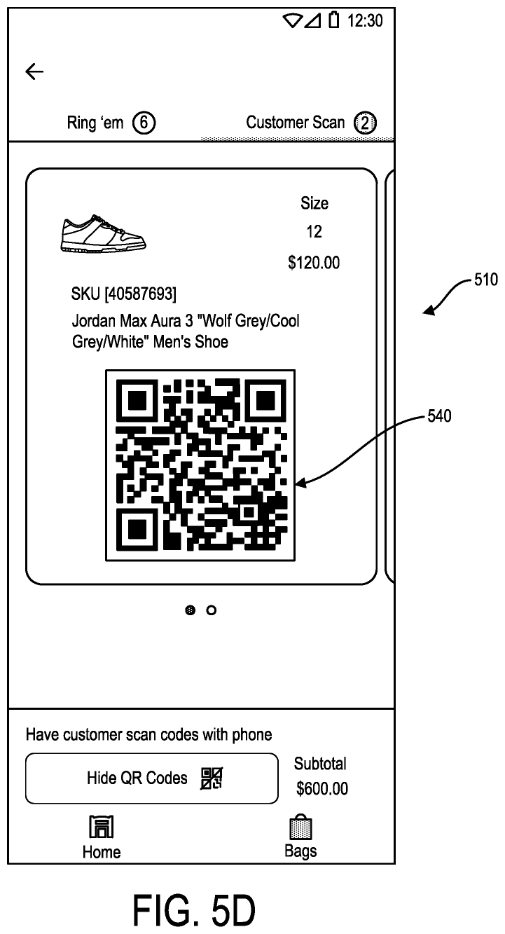

FIG. 5A illustrates an example of a virtual shopping bag according to one or more example embodiments. Referring to FIG. 5A, the virtual shopping bag 500 may be displayed on the mobile in-store terminal, and may display the products that a particular customer wishes to purchase. When a product is added to a virtual shopping bag, the mobile in-store terminal 105 may transmit a request to the inventory database 110, either directly or via server 115, to confirm the availability of the product. The inventory database 110 may search for the product, based on product identification information contained in the request, and transmit a response to the mobile in-store terminal 105, directly or via server 115, indicating whether the product is available, and whether the product is available in the same store as the mobile in-store terminal 105, at a store within the same hub, at another store outside the hub but within the chain of stores, or in online inventory. Although a single inventory database 110 is shown in FIG. 1 for products available at a particular store, within a hub to which the store belongs, within the retail chain of stores, and within online inventory, the retail sales system 100 may include separate databases for products within a particular store, hub, chain, or online.

The products in the virtual shopping bag 500 may be separated based on when the products were added to the virtual shopping bag 500. In addition, the mobile in-store terminal 105 may store multiple virtual shopping bags corresponding to different customers. FIG. 5B illustrates a view of a virtual shopping bag 510 according to an example embodiment. The virtual shopping bag 510 may display products that have been added to the virtual shopping bag, and separate the displayed products based on whether the products are located at the same store as the customer and the mobile in-store terminal 105, at a store within the same geographic “hub” as the store the customer is in (in which case the product will be available for pick up or shipped to the customer the next day), or (as shown in FIG. 5D) at a store outside the geographic “hub” or in online inventory (in which case the product will be shipped to the customer). For in-store products, the customer may pay for the in-store products at the fixed store terminal 130 by, for example, scanning a barcode located on a tag of the actual product and remitting payment. For products in the virtual shopping bag 510 that are located at a store within the geographic “hub” of the customer, a barcodes option 520 may be selected to display a barcode 530 (as shown in FIG. 5C) corresponding to such products, which when scanned at the fixed store terminal 130, will allow the customer to remit payment. According to an example embodiment, the mobile in-store terminal 105 may be configured to receive payment information via, for example, credit card or any other electronic payment methods. For products located at stores outside of the hub where the customer and mobile in-store terminal 105 are located, or products located in online inventory, the virtual shopping bag 510 may display a QR code 540, or the like, that when scanned by a camera on the customer's mobile device, allows the customer to purchase the product via the customer's mobile device as a typical online transaction. Alternatively, the sales associate may be able to scan the OR code 540 using the fixed store terminal 130, and allow the customer to purchase products available in-store, within the hub, within the chain, or in online inventory in a single transaction. In this way, the customer is able to efficiently identify multiple complementary items, which may be located at various locations within the retailer's footprint, and purchase those items simultaneously with various options for pickup or shipping.

Although the example embodiments discussed above have been described in the context of automotive or industrial applications, the exemplary embodiments are not limited to such applications and can apply to many other applications.

Many different embodiments have been disclosed herein, in connection with the above description and the drawings. It will be understood that it would be unduly repetitious to literally describe and illustrate every combination and subcombination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A retail sales system comprising:
a mobile in-store terminal having a processor configured to execute a software application configured to receive product search information relating to a requested product;
a database configured to store product detail information for a plurality of products; and
a server configured to receive the product search information from the mobile in-store terminal, identify one or more products corresponding to the product search information, and obtain product detail information related to each of the one or more products from the database, and provide the product detail information related to each of the one or more identified products to the mobile in-store terminal;
wherein the mobile in-store terminal is configured to receive product search information that includes a product image of the requested product, a unique visual code corresponding to the requested product, a text code corresponding to the requested product, and a text description corresponding to the requested product.

2. The retail sales system of claim 1, wherein the product search information comprises the requested product image;
wherein the server includes an image processing unit having a processor configured to extract image data from the requested product image; and
wherein the server is configured to identify the one or more products based on the extracted image data.

3. The retail sales system of claim 2, wherein the server is configured to identify, based on the extracted image data, additional products having a color, shape, or type corresponding to the one or more identified products.

4. The retail sales system of claim 1, wherein the product search information includes size information relating to the requested product, and wherein the product detail information provided by the server to the mobile in-store terminal indicates availability of each of the one or more identified products having a size with a predetermined range of the size information.

5. The retail sales system of claim 1, wherein the product detail information provided by the server to the mobile in-store terminal includes location information for each of the one or more identified products.

6. The retail sales system of claim 5, wherein the location information for each of the one or more identified products indicates whether the product is located at a physical store where the mobile in-store terminal is located, at a physical store within a predetermined distance of the physical store where the mobile in-store terminal is located, at a physical store outside of the predetermined distance of the physical store where the mobile in-store terminal is located, or in online inventory.

7. The retail sales system of claim 1, wherein the database is configured to store complementary product information related to complementary products associated with one or more of the plurality of products; and
wherein the server is configured to provide to the mobile in-store terminal complementary product information related to complementary products associated with each of the one or more identified products.

8. The retail sales system of claim 1, wherein the mobile in-store terminal is configured to create a plurality of virtual shopping bags respectively corresponding to a plurality of customers, and add products to the plurality of virtual shopping bags based on a user input; and
wherein the mobile in-store terminal is configured to delete a virtual shopping bag of the plurality of virtual shopping bags based on the virtual shopping bag not being accessed for a predetermined period of time.

9. The retail sales system of claim 6, wherein the mobile in-store terminal is configured to create and display a plurality of virtual shopping bags respectively corresponding to a plurality of customers, and add products to the plurality of virtual shopping bags based on user input;
wherein, when displaying products of a virtual shopping bag, the mobile in-store terminal is configured to display a unique visual code for each product located at a physical store within a predetermined distance of the physical store where the mobile in-store terminal is located, or at a physical store outside of the predetermined distance of the physical store where the mobile in-store terminal is located; and
wherein the server is configured to initiate a first payment and shipping process for each product in the virtual shopping bag located at a physical store within or outside a predetermined distance of the physical store where the mobile in-store terminal is located, based on the unique visual code for said each product.

10. The retail sales system of claim 9, wherein when displaying products of a virtual shopping bag, the mobile in-store terminal is configured to display a unique visual code for each product located in online inventory; and
wherein the server is configured to initiate a second payment and shipping process for each product in the virtual shopping bag located in online inventory, based on the unique code for each said product located in online inventory.

11. The retail sales system of claim 1, wherein the product search information comprises the unique visual code corresponding to the requested product;
wherein the mobile in-store terminal includes a visual code scanner configured to decode the unique visual code and transmit decoded information to the server;
wherein the server is configured to identify the one or more products based on the decoded information; and
wherein the server is configured to identify additional products having a color, shape, or type corresponding to the one or more identified products.

12. The retail sales system of claim 1, wherein the product search information comprises the text code corresponding to the requested product;
wherein the server is configured to identify the one or more products based on the text code; and
wherein the server is configured to identify additional products having a color, shape, or type corresponding to the one or more identified products.

13. The retail sales system of claim 1, wherein the product search information comprises the text description corresponding to the requested product;
wherein the server is configured to identify the one or more products based on the text description; and
wherein the server is configured to identify additional products having a color, shape, or type corresponding to the one or more identified products.

14. A method of using a retail sales system, the method comprising:
receiving, at a mobile in-store terminal, product search information relating to a requested product;
storing product detail information for a plurality of products;
receiving the product search information from the mobile in-store terminal;
identifying one or more products corresponding to the product search information; and
providing product detail information related to each of the one or more identified products to the mobile in-store terminal;
wherein the mobile in-store terminal is configured to receive product search information that includes a product image of the requested product, a unique visual code corresponding to the requested product, a text code corresponding to the requested product, and a text description corresponding to the requested product.

15. The method of claim 14, wherein the product search information comprises the requested product image, and the method comprises:
extracting image data from the requested product image;
wherein said identifying the one or more products corresponding to the produce search information includes identifying said one or more products based on the extracted image data.

16. The method of claim 15, further comprising identifying additional products having a color, shape, or type corresponding to said one or more identified products.

17. The method of claim 14, wherein the product search information includes size information relating to the requested product, and wherein the product detail information provided to the mobile in-store terminal indicates availability of each of the one or more identified products having a size with a predetermined range of the size information.

18. The method of claim 14, wherein the product detail information provided to the mobile in-store terminal includes location information for each of the one or more identified products, and wherein the location information indicates whether the product is located at a physical store where the mobile in-store terminal is located, at a physical store within a predetermined distance of the physical store where the mobile in-store terminal is located, at a physical store outside of the predetermined distance of the physical store where the mobile in-store terminal is located, or in online inventory.

19. The method of claim 14, further comprising:
storing complementary product information related to complementary products associated with one or more of the plurality of products; and
providing the mobile in-store terminal complementary product information related to complementary products associated with each of the one or more identified products.

20. The method of claim 18, further comprising:
adding one or more of said identified products to a virtual shopping bag;
displaying, on the mobile in-store terminal, products within the virtual shopping bag;
displaying a unique visual code for each product in the virtual shopping bag located at a physical store within a predetermined distance of the physical store where the mobile in-store terminal is located, or at a physical store outside of the predetermined distance of the physical store where the mobile in-store terminal is located; and
initiating a first payment and shipping process for each product in the virtual shopping bag located at a physical store within or outside a predetermined distance of the physical store where the mobile in-store terminal is located, based on the unique visual code for said each product in the virtual shopping bag.
